(19) United States
(12) Patent Application Publication
(10) Pub. No.: US 2023/0205794 A1
(43) Pub. Date: Jun. 29, 2023

(54) GENERATING SEARCH INSIGHT DATA

(71) Applicant: Calabrio, Inc., Minneapolis, MN (US)

(72) Inventors: Kyle Smaagard, Forest Lake, MN (US); Boris Chaplin, Medina, MN (US); Chris Vanciu, Isle, MN (US); Paul Gordon, Minneapolis, MN (US); Matt Matsui, Minneapolis, MN (US); Laura Cattaneo, Rochester, MN (US); Catherine Bullock, Minneapolis, MN (US); Dylan Morgan, Minneapolis, MN (US)

(21) Appl. No.: 18/046,890

(22) Filed: Oct. 14, 2022

Related U.S. Application Data
(60) Provisional application No. 63/293,321, filed on Dec. 23, 2021.

(51) Int. Cl. G06F 16/332; G06F 16/31

(52) U.S. Cl. CPC G06F 16/3323; G06F 16/322; G06F 16/3326

(57) ABSTRACT

The present disclosure relates to generating additional insight data for search results. Individual search results may be obtained and used to generate a parse tree for the search result data. A dependency graph may then be generated using the parse tree, where the dependency graph includes a root node that corresponds to a query parameter. A scoring or weighting algorithm is applied to the dependency graph to generate and aggregate scores for nodes in the dependency graph relative to the root node. The generated scores or weights are used to generate insight data for the search results.

### CROSS-REFERENCE TO RELATED APPLICATIONS

This application claims priority to U.S. Provisional Application No. 63/293,321, filed Dec. 23, 2021, titled “Generating Search Insight Data,” the entire disclosures of which is hereby incorporated herein by reference.

### BACKGROUND

Various tools exist for performing text searches across a corpus of documents, contacts, and/or resources. Generally, these tools surface results based upon a keyword match. When searching textual resources, the results may include a segment of text surrounding the matching keyword. However, existing search systems fail to provide contextual analysis of the results across the corpus. Particularly when dealing with diverse subject matter, the lack of analysis requires users to manually review the search results in order to identify relevant search results and then manually reconstruct a query to provide a relevant set of results to the user.

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY

Aspects of the present disclosure relate to generating insight data for a set of search results. For example, a search query be executed on a set of resources, such as a corpus of transcripts, emails, text messages, documents, other forms of data or resources, a combination of resources, etc., to generate an initial set of search results. In examples, search results may be individually processed to determine insight data about the result. For example, a parse tree may be generated for a sentence containing a keyword from the search query. The parse tree can be used to generate a dependency graph. A scoring algorithm may then be performed on the dependency graph to score the nodes in the graph based upon their relationship to the keyword from the search query. The scores are analyzed to generate insight data, e.g., contextual information, about the search result. The initial set of search results can then be provided with the generated insight data.

Further aspects of the present disclosure provide for refining the initial set of search results based upon the insight data. For example, a selection of a particular piece of insight data may be received. The initial set of search results may then be refined based upon the selection of the piece of insight data. The refined results may then be provided in place of, or in addition to, the initial set of search results.

Aspects of the present disclosure further provide a user interface for receiving a search query and, in response, displaying an initial set of search results and corresponding insight data. The insight data may be displayed as activatable user interface components, such that, upon receiving a selection of the insight data, a request to refine the search results based upon the insight data is processed.

This Summary introduces a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary system for generating and providing search insights for a corpus of resources.

FIG. 2 depicts an exemplary method for gathering and preprocessing searchable data.

FIG. 3 depicts an exemplary method for generating insight data when performing a search.

FIG. 4 depicts an exemplary method 400 for generating parse trees for search results.

FIG. 5 depicts an exemplary parse tree that may be generated as part of a process to generate insight data.

FIG. 6 depicts an exemplary method for generating insight data using a dependency graph.

FIG. 7 depicts an exemplary dependency graph generated for a search result.

FIG. 8 depicts an exemplary method for refining an initial search based upon insight data.

FIG. 9 depicts an exemplary user interface for displaying search results and insight data.

FIG. 10 illustrates a simplified block diagram of a device with which aspects of the present disclosure may be practiced in accordance with aspects of the present disclosure.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

Traditional search systems are operable to receive a search query, and process the query parameters against a body of resources to generate search results. However, these systems generally provide the search results without any additional data. As such, users are required to sift through the search results to determine whether the results capture the user's intent or interest. This scenario generally results in a situation in which users have to generate and run additional queries multiple times before they are able to generate a set of results that are useful to the user. Ultimately, this leads to an inefficient use of the user's time, increased bandwidth usage to receive multiple search results sets, and increased use of processing power and server load required to generate the search results.

Aspects of the present disclosure address these issues, among providing other benefits, by processing search results to generate insight data about the results. The insight data is contextual information about the search results. For example, the insight data may identify topics, terms, or values that are commonly associated with the sets of results. The insight data may be generated by performing additional analysis on the search results. For example, various types of data structures generated herein, such as the parse trees and dependency graphs, allow for the efficient generation of insights for massive corpus of data in a computationally efficient manner, thereby improving performance over existing prior solutions. For ease of explanation, aspects disclosed herein will be described with the example of searching a corpus of call transcript data. However, one of skill in the art will appreciate that the aspects disclosed herein may be practiced in other scenarios in which searches are performed on other type of data, such as, but not limited to emails, text messages, documents, other forms of data or resources, a combination of resources.

Upon generating the initial set of search results, individual search results may be individually processed to determine insight data about the result. For example, a parse tree may be generated for a sentence containing a keyword from the search query. The parse tree can be used to generate a dependency graph in which the keyword is a root node of the graph. A scoring algorithm may then be performed on the dependency graph to score the nodes in the graph based upon their relationship to the root node. The scores are analyzed to generate insight data, e.g., contextual information, about the search result. The initial set of search results can then be provided with the generated insight data.

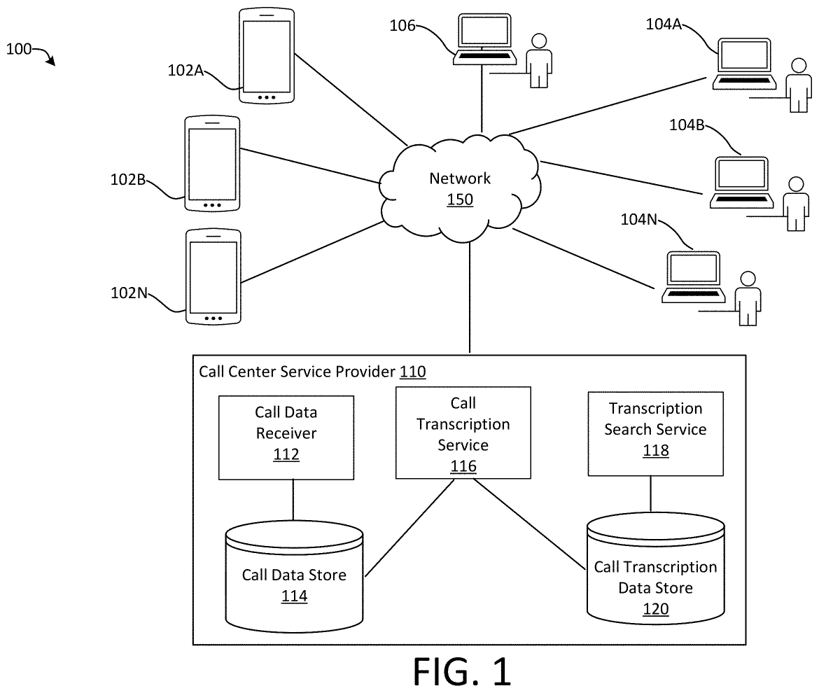

FIG. 1 depicts an exemplary system 100 for generating and providing search insights for a corpus of resources. System 100 depicts a contact center including a transcription search service 118. For ease of explanation, examples disclosed herein will be based upon the exemplary contact center. However, one of skill in the art will appreciate that the exemplary aspects of the transcription search insights disclosed herein may be employed in other systems, such as a file system, a cloud service data center, or the like. As such, aspects disclosed herein are not limited to the exemplary systems. Rather, one of skill in the art will appreciate that the systems and methods disclosed herein can be employed to systems other than contact centers and provide search insights on other types of data.

The exemplary system 100 comprises a client devices 102A-N communicating with service provider devices 104A-N via network 150. In aspects, the client-computing device 102A-N may include a smartphone and/or a phone device where a user may participate in a call or join a conversation with another speaker. In further aspects, the client computing devices 102A-N may be a personal computer, a tablet computing device, a laptop, or any other computing device which allows users to communicate over a network via audio, video, and/or textual communications. Similarly, service provider devices 104A-N may be a smartphone, a phone, a personal computer, a tablet computing device, a laptop, or any other computing device which allows users to communicate over a network via audio, video, and/or textual communications. The network 150 may be a computer communication network, such as the Internet, a local area network (LAN), a wide area network (WAN), or the like. Additionally or alternatively, the network 150 may include a public or private telecommunication network exchange to interconnect with ordinary phones (e.g., the phone devices).

System 100 may also include a query computing device 106. The query computing device 106 may be operable to generate and send queries to the contact center service provider 110 via network 150. Alternatively, query computing device 106 may be part of the contact center service provider 110. Query computing device 106 is operable to generate and submit queries search data associated with the contact center service provider 110. In the exemplary system 100, the data relates to call data, e.g., audio logs, call transcripts, etc., representing communications transmitted between client computing devices 102A-N and service provider devices 104A-N. Again, while examples of the present disclosure are described with respect to searching call data and/or call transcripts associated with the contact center service provider 110, one of skill in the art will appreciate that the exemplary system 100 can be employed with other types of service providers to search other types of data.

In the exemplary system, communications between the client computing devices 102A-N and service provider devices 104A-N may be captured by the call data receiver 112. For example, the call data receiver may receive communication data transmitted between client device 102A and service provider device 104A. The communicated data may comprise audio data, video data, textual data, or a combination of the above. Call data receiver 112 stores the communication data in call data store 114. In examples, call data store 114 may store a copy of the original communication data. Call transcription service 116 may access the stored communication data and translate the data into a searchable format. For example, call transcription service may access an audio log of a call between client device 102A and service provider device 104A and process the audio data using a natural language processor to generate a text transcript of audio data. Similarly, audio data from a video file may be processed using a natural language processor to generate a text transcript of the audio portion of the video file. While call transcription service 116 is described as generating text transcripts of the call data, one of skill in the art will appreciate that the call transcription service may be operable to process the call data to transform the data into any type of format that may queried by a search service without departing from the scope of this disclosure. In still further aspects, the call transcription service 116 may index the data or perform other types of optimization of the stored call data. Finally, while call transcription service 116 is described as a separate service from the call data receiver 112, one of skill in the art will appreciate that the data processing and/or optimizations performed by the call transcription service 116 may be performed at the time the call data is received by the call service provider 110. Call transcription service 116 may store the processed call data in call transcription data store 120.

Transcription search service 118 is operable to receive a query for data stored in the call transcription data store 120. For example, the transcription search service may be operable to receive a query from query computing device 106 and execute the query on the transcription data stored in the call transcription data store 120. However, unlike existing solutions, transcription search service 118 is operable to generate and provide insights, e.g., additional metadata related to the search query, contextual information, statistics, or the like, when processing the query. In examples, the transcription search service may generate an initial set of search results based upon the query. The initial set of search results may be processed to generate the insights. For example, an initial set of results may be generated based upon one or more query parameters. The initial sets of results may be further processed to determine additional information about the results. For example, upon identifying a keyword (e.g., a query parameter) in the transcription data, the sentence containing the keyword may be included in the initial set of search results. The transcription search service may generate a dependency graph of the sentence. The dependency graph may be analyzed to determine and evaluate the relationship between the query parameter and other words in the sentence. For example, the dependency graph may be input into a machine learning model to analyze the relationship between the query parameter and other words in the sentence (or multiple sentences of the transcript) and generate a list of related words and a numeric value indicating the strength of the relationship or a related word to the query parameter.

In examples, the transcription search service may perform a similar analysis on other sentences in the initial set of search results. The data representing the relationships between the words and the query parameters generated by the transcription search service 118 may be aggregated to provide insight data (e.g., contextual information, statistics, etc.) in addition to the initial set of search results. The insight data may be provided along with the initial set of search results generated in response to receiving the query. Alternatively, or additionally, the transcription search service 118 may process the initial set of search results using the insight data to generate a refined set of search results. In doing so, the transcription search service 118 generates and provides actionable information in response to receiving a search query by, for example, surfacing a prioritized list about how the search term is being used and/or referenced. For example, if the contact center handles calls from a hotel chain, they may be interested in how customers are referencing their bathrooms. A query for a transcription search including the keyword “bathroom” may be received. Among other benefits, rather than requiring the user to manually review all of the search results, the transcription search service 118 may generate and provide insight data, for example, by producing a list like the following:

Small bathroom (0.9)
Dirty bathroom (0.85)
Clean bathroom (0.5)

In doing so, the transcription search service 118 generates data in response to the query that provides additional information that allows a user to see that the majority of the times that a bathroom is being discussed it is referenced as small or dirty. This could allow the user to take further action by reviewing the specific calls or cross-referencing locations to identify the deeper issue. Among other benefits, the transcription search service 118 provides a more detailed search interface providing additional information to the user, and in doing so, reduces the number of queries that must be generated, received, and processed in order to identify relevant information. As such, the transcription search service 118 provides the exemplary benefits of limiting use of bandwidth required to receive query requests and transmit query results, reducing the processing resources needed to search stored data, reducing server loads reducing server response times, and the like.

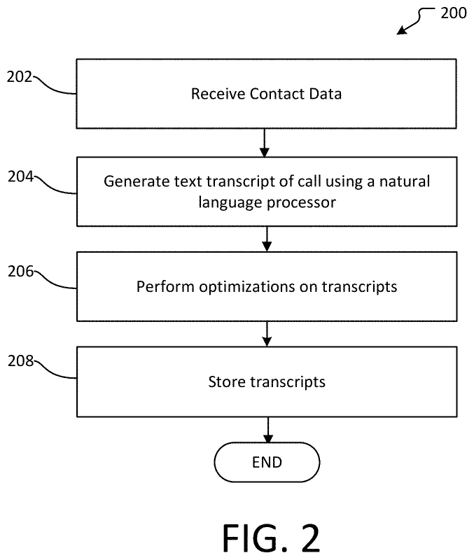

FIG. 2 depicts an exemplary method 200 for gathering and preprocessing searchable data. As discussed above, for ease of explanation the method 200 is described in the exemplary situation of preprocessing data at a contact center. However, one of skill in the art will appreciate that the method 200 may be employed to process other types of data and used with other systems, such as a cloud data service, a file directory, a generic search service, or the like. A general order of the operations for the method 200 is shown in FIG. 2. The method 200 may include more or fewer steps or may arrange the order of the steps differently than those shown in FIG. 2. The method 200 can be executed as a set of computer-executable instructions executed by a cloud system and encoded or stored on a computer readable medium. Further, the method 200 can be performed by gates or circuits associated with a processor, an ASIC, an FPGA, a SOC or other hardware device.

Flow begins at operation 202 where contact data is received. The received contact data may be in any form or format used to communicate information between two users. The contact data may be an audio file or data stream of a phone call, one or more text messages, a messaging application conversation, a video file, or the like. Upon receiving the contact data, flow proceed to operation 204 where the contact data is processed using a natural language processor to generate a transcript of the contact. For example, when the contact data is audio or video, the spoken utterances are processed by a natural language processor to generate a text transcript of the conversation. Alternatively, if the contact data is already in a text format (e.g., a text message, email, etc.), operation 204 may be skipped, or other processing may be done to aggregate or otherwise arrange one or more of the messages into a conversation. In further examples, a natural language processor may still be employed to determine contextual information from the received text files. While operation 204 describes generating a text transcript of the contact, one of skill in the art will appreciate that other types of formats may be generated using the received contact data at operation 204. For example, the received contact data may be processed to transform the received data into a searchable format.

Similarly, at operation 206, additional processing may be performed to optimize the received contact data for searching. For example, the transcripts generated at operation 204 may be indexed to optimize for searching. One of skill in the art will appreciate that performing additional processing of the transcript at operation 206 may result in more efficient searching later. However, operation 206 may be optional and can be skipped without departing from the scope of this disclosure. Once the transcripts are generated and optimizations are optionally performed, flow continues to operation 208 where the generated transcripts are stored.

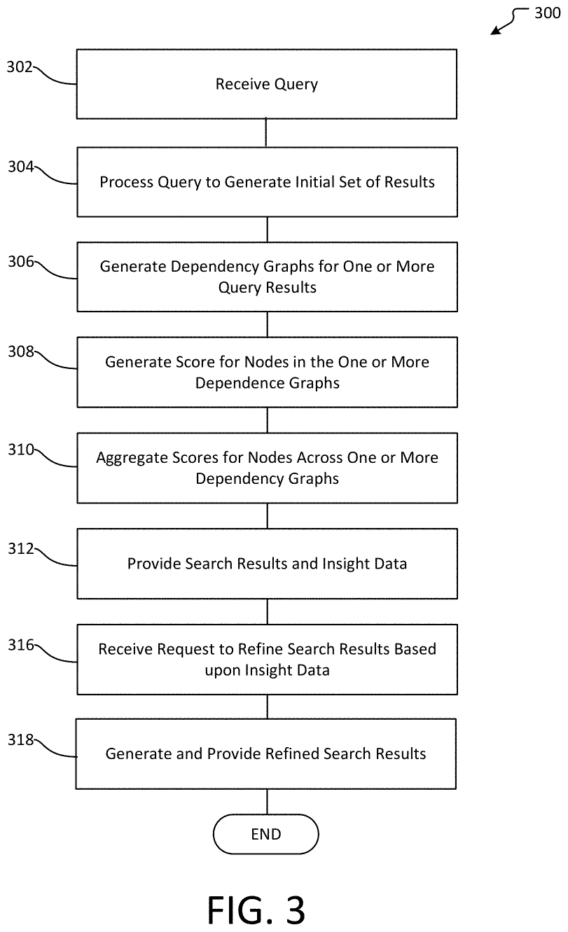

FIG. 3 depicts an exemplary method 300 for generating insight data when performing a search. For example, the method 300 may be employed by transcription search service 118 to generate insight data when performing a search. As discussed above, for ease of explanation the method 300 is described in the exemplary situation of preprocessing data at a contact center. However, one of skill in the art will appreciate that the method 300 may be employed to process other types of data and used with other systems, such as a cloud data service, a file directory, a generic search service, or the like. A general order of the operations for the method 300 is shown in FIG. 3. The method 300 may include more or fewer steps or may arrange the order of the steps differently than those shown in FIG. 3. The method 300 can be executed as a set of computer-executable instructions executed by a cloud system and encoded or stored on a computer readable medium. Further, the method 300 can be performed by gates or circuits associated with a processor, an ASIC, an FPGA, a SOC or other hardware device.

Flow begins at operation 302, where a query is received. The received query may include one or more parameters. For example, the parameters may specify a keyword or phrase, a time or period of time, a subset of the corpus to be searched, or the like. One of skill in the art will appreciate that any type of query parameters may be received at operation 302. The query may be directed towards a corpus of resources. Continuing with the above example, the corpus of resources may be contact transcripts received at a service center. In response to receiving the query, flow proceeds to operation 304 where the query is processed to generate an initial set of search results. As an example, a query having the keyword “insurance” may be executed on a transcript data store, such as call transcript data store 120 of FIG. 1. The initial set of search results generated at operation 304 will include a list of all transcripts that include the word “insurance.” The initial set of search results may include, but are not limited to, an identifier to a transcript, a sentence containing the query parameter (i.e., the keyword “insurance” in the example), a segment of text containing the query parameter, one or more user identifiers identifying the participants in the conversation, a contact identifier identifying the contact or the type of contact (e.g., call, messages, email, etc.), or any other type of relevant data that satisfies the query or can be used to generate insight data.

Continuing to operation 306, once the initial set of search results has been generated, a subset of the data related to the one or more search results may be analyzed to determine a dependency graph. Continuing the example above, one or more sentences containing the key word “insurance” may be processed at operation 306 to generate a dependency graph for each of the one or more sentences. In examples, a dependency graph may be generated for one or more sentences around the sentence containing the query parameter (i.e., the keyword “insurance” from the example). For example, a dependency graph may also be generated for one or more sentences preceding and/or one or more sentences following the sentence containing the query parameter. In examples, a dependency graph may generated based upon a parse tree for a sentence.

Once the dependency graph has been generated for one or more sentences of the search results, flow continues to operation 308 where nodes in the one or more dependency graphs are scored. In examples, graph nodes may exist for terms that have parts-of-speech tags that are either nouns or adjectives, are not stop words, contain only alpha characters, and/or either contain the query parameter or are connected to the query parameter in a parse tree generated for the search result. While specific types of nodes are described herein, one of skill in the art will appreciate that the types of nodes included in the dependency graph may vary without departing from the scope of this disclosure. In examples, the nodes may be scored based upon how closely they are connected to a node representing the query parameter. For example, nodes directly connected to the query parameter may receive a score of 1, nodes one connection away from the query parameter may receive a score of 0.5, nodes two connections away from the query parameter may receive a score of 0.25, etc. While specific examples of scoring are described herein, one of skill in the art will appreciate that other types of scoring or weighting algorithms may be employed without departing from the scope of this disclosure.

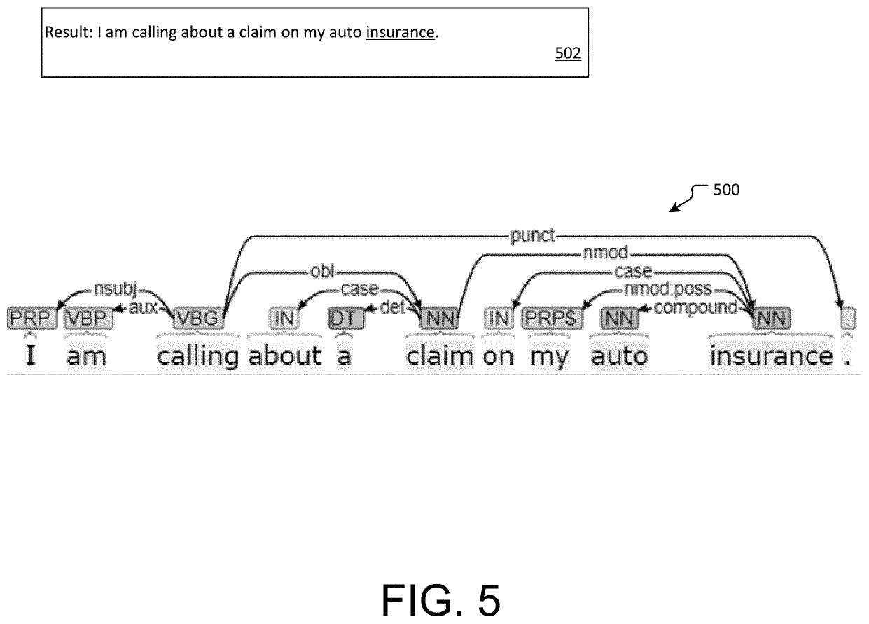

Once the nodes of the one or more dependency graphs have been scored, flow continues to operation 310 where the scores are aggregated across the dependency graphs. For example, the scores of nodes having similar values (e.g., nodes representing the same word, having the same value, etc.) may be aggregated to determine an aggregate score for each node value. The aggregated scores represent insight data for the search results. For example, aggregating scores for the nodes provides information on how often the query parameter is associated with a particular value, a particular term, or a particular context. Additional detail regarding the generation of the parse trees, dependency graphs, and the process scoring is provided below with respect to FIGS. 5-8.

After the insight data is generated at operation 310, flow continues to operation 312 where the initial set of search results is provided with the insight data. For example, the initial search results, e.g., sentences containing the query parameter from the various transcripts, along with the additional insight data generated by the transcription service. The insight data provides contextual information about the search results. Continuing with the above example, the search results for the query “insurance” may include one or more sentences from each transcript containing the word “insurance” along with insight data that contextualizes the search result. For example, the insight data may identify terms associated with the word insurance. For example, insight results for the “insurance” query may include:

Auto insurance (.65)
Life insurance (.25)
Rental insurance (.10)

The exemplary insight data indicates a strength score associating the search term with a particular topic. In the example, a strength score of 0.65 indicates that the term “insurance” is associated with “auto insurance,” a strength score of 0.25 indicating that the term “insurance” is associated with the “life insurance,” and a strength score of 0.10 indicating that the term “insurance” is associated with “rental insurance.” Based upon the strength scores, an insight can be determined that the term insurance is mostly associated with “life insurance” in the search results, with the second results being associated with “life insurance,” etc. The insight data provides additional information, which allows the user to contextualize the results without requiring the user to manually review the results.

At operation 316, a request may be received to refine the search results based upon the insight data. For example, the insight data may be displayed as an interactive element in a search user interface. Upon activation of the insight data, a request to refine the results in accordance with the selected insight data may be received. For example, if “Life insurance” is selected from the example above, a request to refine the search results to display only the results related to “life insurance” may be received. At operation 318, the refined results are generated and provided to the requesting device. For example, the initial set of results may be filtered to show results associated with the selected insight data. Alternatively, or additionally, instead of filtering the initial set of results, a new query may be generated based upon the selected insight data (e.g., a query for “life insurance”) and executed against the corpus of resources. In said example, additional insight data for the new query may be generated as the query is processed.

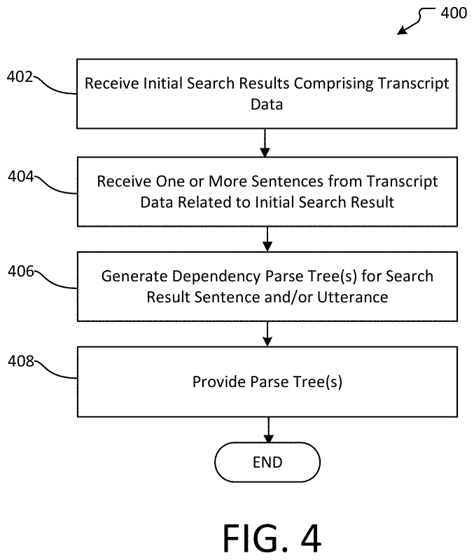

FIG. 4 depicts an exemplary method 400 for generating parse trees for search results. However, one of skill in the art will appreciate that the method 400 may be employed to process other types of data and used with other systems, such as a cloud data service, a file directory, a generic search service, or the like. A general order of the operations for the method 400 is shown in FIG. 4. The method 400 may include more or fewer steps or may arrange the order of the steps differently than those shown in FIG. 4. The method 400 can be executed as a set of computer-executable instructions executed by a cloud system and encoded or stored on a computer readable medium. Further, the method 400 can be performed by gates or circuits associated with a processor, an ASIC, an FPGA, a SOC or other hardware device.

Flow begins at operation 402, where an initial set of search results is received. Continuing with the prior examples, the initial set of search results may include call transcript data associated with a query parameter (i.e., the keyword “insurance”). Flow continues to operation 404, where one or more sentences are identified and selected from the transcript data based upon the initial search results. In one example, only the sentences containing the query parameter may be selected from the transcript data. Alternatively, or additionally, other related sentences may be selected at operation 404, for example, the preceding sentence, the subsequent sentence, the entire utterance, etc.

At operation 406, a parse tree is generated for the selected sentence. For example, a natural language processor may receive the selected sentence as input and output a parse tree. Alternatively, the sentence may be provided as input to a machine learning model which outputs a parse tree for the sentence. FIG. 5 depicts an exemplary parse tree 500, which may be generated at operation 406. In the depicted example, the search result “I am calling about a claim on my auto insurance” 502 may be part of an initial set of search results returned when processing a query including the keyword “insurance.” For example, the search result 502 may be input to a natural language processor to generate the parse tree 500. The parse tree 500 represents the syntactic structure of the sentence, classifying the part of speech for the individual terms and the relationship between the terms.

Returning to operation 406, a parse tree may be generated for all of the initial search results or a subset of the initial search results. In examples, the parse trees may be saved for future search results. For example, the generated parse trees may be stored in a parse tree data store and associated with their related sentences. In such circumstances, upon receiving a search result, the parse tree data store may be accessed to determine if a parse tree has already been generated for the search result. If so, the parse tree may be retrieved from the data store instead of being generated at operation 406. One the parse trees are generated, flow continues to operation 408, where the parse trees are provided to a requesting user or application. For example, the parse trees may be provided to a dependency graph generator.

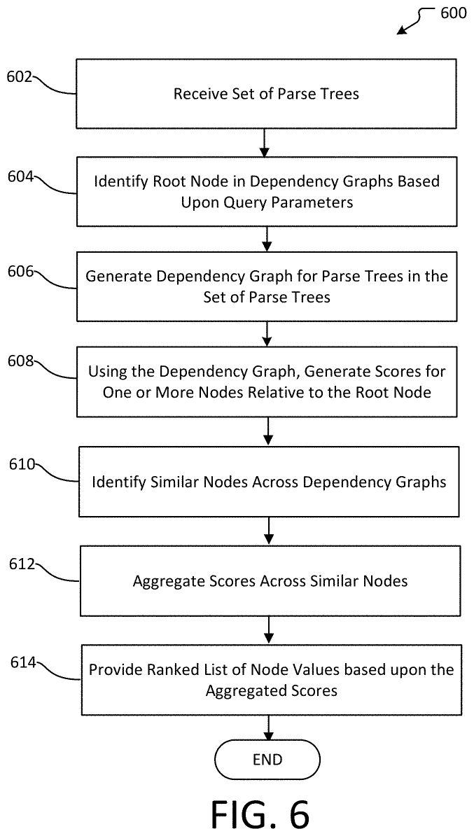

FIG. 6 depicts an exemplary method for generating insight data using a dependency graph. A general order of the operations for the method 600 is shown in FIG. 6. The method 600 may include more or fewer steps or may arrange the order of the steps differently than those shown in FIG. 6. The method 600 can be executed as a set of computer-executable instructions executed by a cloud system and encoded or stored on a computer readable medium. Further, the method 600 can be performed by gates or circuits associated with a processor, an ASIC, an FPGA, a SOC or other hardware device.

Flow begins at operation 602, where a set of parse trees is received. The set of parse trees comprises one or more parse trees for an initial set of search results. In one example, the received parse trees are generated in response to receiving an initial set of search results. However, in alternate aspects, the parse trees received at operation 602 may have been generated prior to the generation of the initial set of search results. Each parse tree generated at operation 602 corresponds to a different contact. For example, a parse tree may be generated for each call transcript identified in the initial set of search results. At operation 604, a root term is identified for the search result. In examples, the root term is identified based upon the one or more parameters of the query associated with the search results. For example, the root term may be a keyword associated with the query. The root term may be the root node for the dependency graph generated by the method 600. At operation 606, a dependency graph is generated for one or more parse trees from the set of parse trees. For example, based upon a parse tree, a graph is created where the edges are directed (from the head to the dependent). Nodes exist for terms in the parse tree that have parts-of-speech tags that are either nouns or adjectives, are not stop words, contain only alpha characters, and either contain the search term or are connected to the search term in the parse tree. While specific types of nodes are described herein as being included in the graph, one of skill in the art will appreciate that other types of terms may be included without departing from the scope of this disclosure.

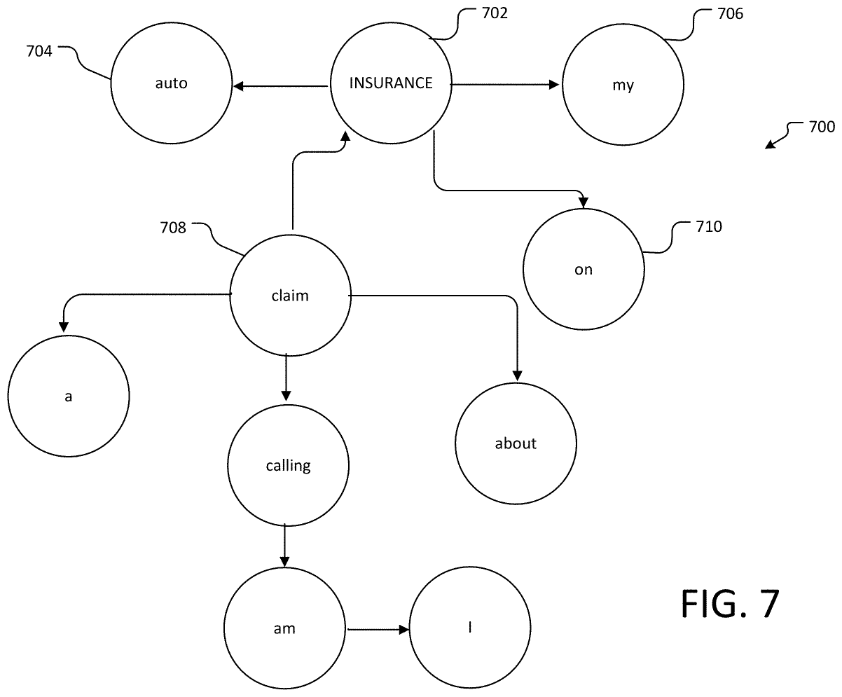

Turning now to FIG. 7, an exemplary dependency graph 700 generated for a search result is depicted. As shown in FIG. 7, the generated dependency graph 700 may include the query parameter as a root node. The dependency graph 700 depicted in FIG. 7 is a dependency graph generated based upon the exemplary search result 602 and parse tree 600 depicted in FIG. 6. Continuing with the above example of a query for “insurance,” dependency graph 700 include root node 702 that represents the term “insurance” from a search result. As shown in FIG. 7, the root node 702 is directly connected two four other nodes: “auto” node 704, “my” node 706, “claim” node 708, and “on” node 710. Exemplary dependency graph 700 is a directed graph. The edge direction is based upon the term relationships depicted in the related parse tree.

Returning to FIG. 6, a dependency graph may be generated for each parse tree (corresponding to each search result from the initial set of search results) received at operation 602. Alternatively, a dependency graph may be generated for a subset of parse trees received at operation 602. Upon generation of the set of dependency graphs, flow continues to operation 608 where a score or weight is calculated nodes in the dependency graph. One of skill in the art will appreciate that a number of different weighing or scoring algorithms may be performed at operation 608 without departing from the scope of this disclosure. For example, a PageRank algorithm may be used to on the dependency graph to determine scores for nodes relative to the root node (e.g., query parameter). In applying the PageRank algorithm, the edges of the dependency graph may be treated as links between webpages. Alternatively, or additionally, nodes may be scored based upon how closely they are connected to a node representing the query parameter. For example, nodes directly connected to the query parameter may receive a score of 1, nodes one connection away from the query parameter may receive a score of 0.5, nodes two connections away from the query parameter may receive a score of 0.25, etc.

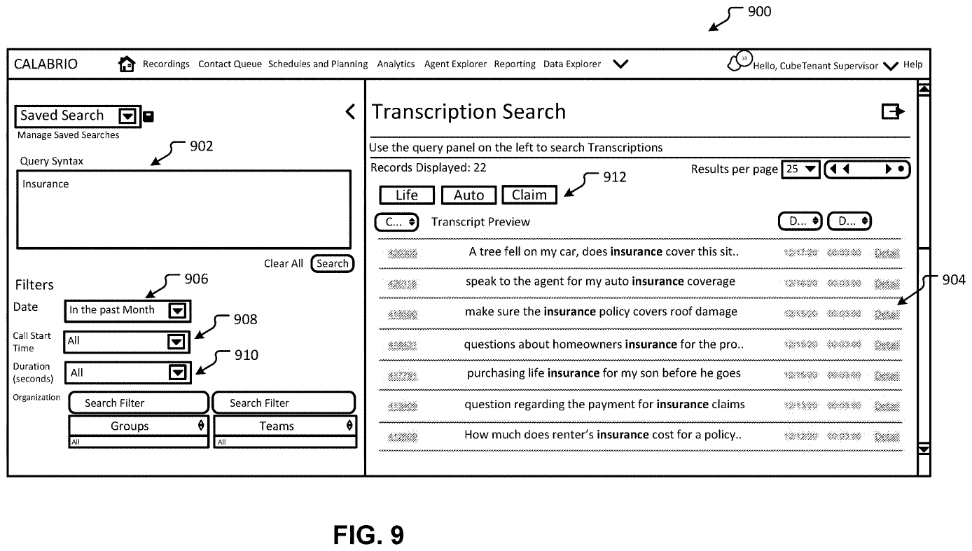

Upon calculating the scores for the different dependency graphs, flow continues to operation 610 where similar nodes are identified in the different dependency graphs. For example, the value of a node may be compared to other nodes to determine which nodes have a similar value (e.g., represent the same word in a sentence). Upon identifying similar nodes, flow continues to operation 612 where the scores or weights calculated across the different dependency graphs are aggregated for each similar node. By aggregating the scores for nodes across the dependency graphs, the method 600 is able to determine a score or ranking for particular values (e.g., phrases or words in a call transcript) by their relevance to the one or more search query parameters. The ranked lists of terms are representative of the insight data generated using the aspects disclosed herein. At operation 614, the ranked list of node values may be provided. In certain aspects, not all terms may be provided at operation 614. Rather, terms meeting a minimum threshold score or weight may be provided, thereby providing a ranked list of values that is more relevant to the one or more query parameters and more easily parsed than a list that includes all related words. In certain aspects, providing the ranked list of node values may comprise sending the ranked list to a requesting application, or displaying the terms in a user interface, as will be discussed in more detail with respect to FIG. 9.

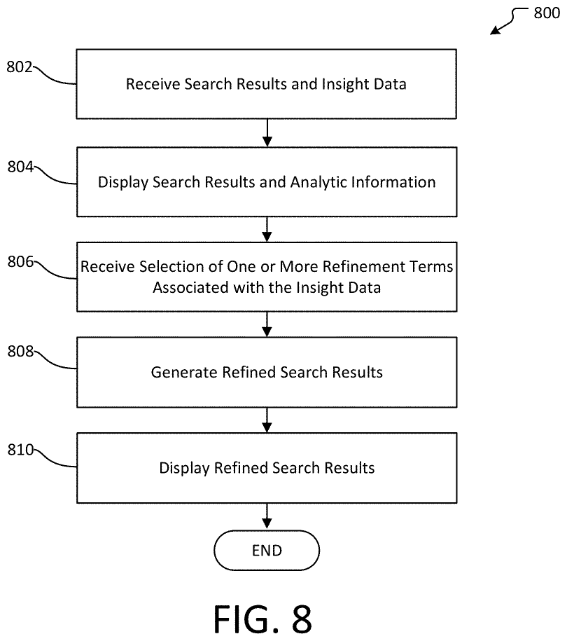

FIG. 8 depicts an exemplary method 800 for refining an initial search based upon insight data. A general order of the operations for the method 800 is shown in FIG. 8. The method 800 may include more or fewer steps or may arrange the order of the steps differently than those shown in FIG. 8. The method 800 can be executed as a set of computer-executable instructions executed by a cloud system and encoded or stored on a computer readable medium. Further, the method 800 can be performed by gates or circuits associated with a processor, an ASIC, an FPGA, a SOC or other hardware device.

Flow begins at operation 802 where search results and insight data is received. The received search results and insight data may have been generated in request to receiving a query, such as a query to identify transcripts having a particular keyword. Flow continues to operation 804 where the search results and insight data is displayed in a user interface. An exemplary user interface is shown in FIG. 9. At operation 804, the results displayed in the user interface may include a listing of resources (e.g., transcripts, documents, files, emails, etc.) that match one or more query parameters. In examples, the results may include a link to the matching resources, as well display a portion of the resource associated with the query parameter. For example, the sentence containing the keyword may be displayed. The insight data may also be displayed with the search results. As previously discussed, the insight data provides contextual information about the initial set of search results. Continuing the “insurance” search example, the insight data may include terms commonly associated with the “insurance” keyword. For example, if the search results are commonly associated with “life insurance,” “auto insurance,” or “insurance claims,” the terms “life,” “auto,” or “claim” can be displayed as insight data, as shown in FIG. 9.

Flow continues to operation 806, where a selection of a query refinement may be received. The query refinement options may be the generated insight data. For example, in certain aspects the insight data may be displayed as an activatable user interface element. For example, the insight data terms may be displayed as a hyperlink, associated with a button, or the like. In such circumstances, individual instances of insight data may be selectable via the user interface element associated with instance. Upon receiving selection of the query refinement term, flow continues to operation 808, where a refined set of search results is generated. In one example, the refined set of search results is generated by filtering the initial search results based upon the selected refinement term. Alternatively, or additionally, generation of the refined search result may include executing a new query with the refinement term included as an additional query parameter along with the initial query parameters.

In certain aspects, the initial search results may be cached or stored, thereby allowing for the quick retrieval of the initial search results. In doing so, different instances insight data may be selected as a refinement terms and a new set of refined search results may be quickly generated. Flow continues to operation 810, where the refined search results are displayed. In one example, the refined search results may be displayed in place of the initial search results. Alternatively, the refined search results may be displayed in conjunction with the initial set of search results.

FIG. 9 depicts an exemplary user interface 900 for displaying search results and insight data. The exemplary user interface 900 is a user interface for searching call transcripts. User interface 900 includes a query parameter interface element 902. For example, the query parameter interface element 902 may be a text box operable to receive one or more keywords as query parameters. The keywords received in the query parameter interface element 902 may be used to generate the search results, as shown in the search result area 904. The exemplary user interface 900 may include other types of elements, which allow the user to set other types of query parameters. For example, the user interface 900 may include a date element 906 that allows the user to define a specific data or date range as a query parameter. The user interface 900 may also include a start time element 908 that can define a specific start time, or range of start times, as a query parameter. A duration element 910 may be define a query parameter related to call length. Additionally, the user interface may include elements to define additional query parameters, like specifying a team or group to search.

Exemplary user interface 900 also includes an insight data area 912. Insight data area 912 displays one or more instances of contextual information. The contextual information determined based upon the initial search results. In examples, insight data may be only displayed in insight data area 912 that meets a threshold score, weight, as described herein. As discussed above, the insight data displayed in area 912 may be interactable interface elements. Upon receiving a selection of one of insight data instances, via activation of an associated interactable interface elements, refined search results may be generated and displayed, for example, in search results area 904. While the insight data shown elements depicted in the insight data area 912 relate to terms in the initial set of search results associated with the query parameter (e.g., “life,” “auto.” or “claim”), the insight data is not limited to specific terms or keywords. For example, the insight data may include time or group information.

Although not shown in FIG. 9, alternate forms of a user interface may be employed without departing from the scope of this disclosure. For example, a word cloud may be generated based upon the insight data. In examples, the word cloud may be a cluster of terms or phrases identified in the insight data. The terms or phrases may be visually distinct based upon their prevalence in the insight data. For example, more common terms in the insight data may be bolded or displayed larger in the word cloud. Alternatively, or additionally, a strength score for the terms may be displayed, for example, when selecting or hovering over a specific term or phrase in the word cloud, or in a table displayed in the user interface.

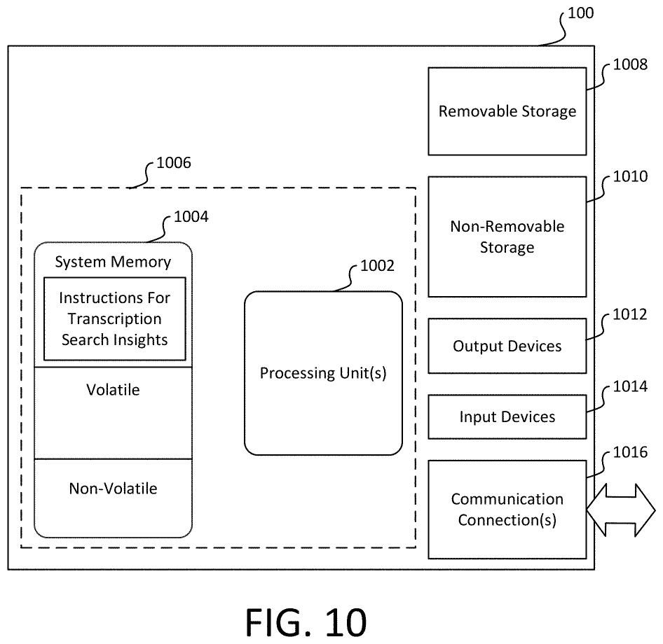

FIG. 10 illustrates a simplified block diagram of a device with which aspects of the present disclosure may be practiced. The device may be a mobile computing device, for example. One or more of the present embodiments may be implemented in an operating environment 1000. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1000 typically includes at least one processing unit 1002 and memory 1004. Depending on the exact configuration and type of computing device, memory 1004 (instructions to perform a cellular-communication-assisted PPV as described herein) may be volatile (such as RAM), non-volatile (such as ROM, flash memory, etc.), or some combination of the two. This most basic configuration is illustrated in FIG. 10 by dashed line 1006. Further, the operating environment 1000 may also include storage devices (removable, 1008, and/or non-removable, 1010) including, but not limited to, magnetic or optical disks or tape. Similarly, the operating environment 1000 may also have input device(s) 1014 such as remote controller, keyboard, mouse, pen, voice input, on-board sensors, etc. and/or output device(s) 1012 such as a display, speakers, printer, motors, etc. Also included in the environment may be one or more communication connections, 1016, such as LAN, WAN, a near-field communications network, a cellular broadband network, point to point, etc.

Operating environment 1000 typically includes at least some form of computer readable media. Computer readable media can be any available media that can be accessed by processing unit 1002 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1000 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method for generating transcription insight data, the method comprising:
receiving an initial set of search results, the initial set of search results generated based upon a query parameter;
receiving a set of sentences from the initial set of search results;
generating a set of parse trees for each sentence in the set of sentences, wherein a parse tree comprising a plurality of terms;
generating one or more dependency graphs for one or more parse trees from the set of parse trees, wherein a dependency graphs comprises:
the query parameter as a root node; and
a plurality of nodes associated with the plurality of terms from an associated parse tree;
determining, for the one or more dependency graphs, a plurality of scores, wherein a score from the plurality of scores is associated with a node from the plurality of nodes in the dependency graph, and wherein the score represents a relationship between a term associated with the node and the query parameter; and
generating, based upon the plurality of scores, insight data for the initial set of search results.

2. The computer-implemented method of claim 1, wherein the plurality of nodes comprise terms that are either nouns or adjectives.

3. The computer-implemented method of claim 2, wherein the plurality of nodes further comprise terms that are connected to the query parameter in an associated parse tree.

4. The computer-implemented method of claim 1, further comprising:
identifying similar nodes in the one or more dependency graphs; and
aggregating scores for the similar nodes, wherein the insight data comprises a ranked list of node values based upon the aggregated scores.

5. The computer-implemented method of claim 4, wherein the similar nodes are associated with an identical term.

6. The computer-implemented method of claim 1, further comprising:
displaying, in a user interface, at least a subset of the initial set of search results and the insight data, wherein the user interface comprises:
a search results area displaying the subset of initial set of search results; and
an insight data area proximate to the search results area, the insight data area displaying the insight data.

7. The computer-implemented method of claim 6, wherein the insight data is displayed as one or more instances of terms, wherein each instance of the one or more instances being an activatable user interface element.

8. The computer-implemented method of claim 6, further comprising:
receiving, via activation of an instance of insight data, a request to refine the initial set of search results;
generating a refined set of search results; and
displaying the refined set of search results.

9. A system comprising:
at least one processor; and
memory encoding computer executable instructions that, when executed by the at least one processor, perform a method comprising:
receiving an initial set of search results that comprise results form a search conducted of transcripts of telephone calls associated with a call center agent, the initial set of search results generated based upon a query parameter;
receiving a set of sentences from the initial set of search results;
generating a set of parse trees for each sentence in the set of sentences, wherein a parse tree comprising a plurality of terms;
generating one or more dependency graphs for one or more parse trees from the set of parse trees, wherein a dependency graphs comprises:
the query parameter as a root node; and
a plurality of nodes associated with the plurality of terms from an associated parse tree;
determining, for the one or more dependency graphs, a plurality of scores, wherein a score from the plurality of scores is associated with a node from the plurality of nodes in the dependency graph, and wherein the score represents a relationship between a term associated with the node and the query parameter;
generating, based upon the plurality of scores, insight data for the initial set of search results;
providing the initial set of search results and the insight data;
receiving a request to refine the initial set of search results, wherein the request is based upon an instance of the insight data; and
in response to receiving the request, generating a refined set of search results.

10. The system of claim 9, wherein generating the refined set of search results comprises filtering the initial set of search results based upon the instance of the insight data.

11. The system of claim 9, wherein generating the refined set of search results comprises executing a second query comprising the query parameter and the instance of the insight data.

12. The system of claim 9, wherein the plurality of nodes comprise terms that are either nouns or adjectives.

13. The system of claim 12, wherein the plurality of nodes further comprise terms that are connected to the query parameter in an associated parse tree.

14. The system of claim 9, wherein generating insight data comprises:
identifying similar nodes in the one or more dependency graphs; and
aggregating scores for the similar nodes, wherein the insight data comprises a ranked list of node values based upon the aggregated scores.

15. The system of claim 10, wherein providing the initial set of search results and the insight data comprises displaying, in a user interface, at least a subset of the initial set of search results and the insight data, wherein the insight data is displayed as one or more instances of terms, wherein each instance of the one or more instances being an activatable user interface element.

16. The system of claim 15, wherein receiving the request to refine the initial set of search results comprising receiving activation of a user interface element associated with an instance of insight data.

17. A computer storage medium comprising computer-executable instructions that, when executed by at least one processor, perform a method comprising:
receiving an initial set of search results, the initial set of search results generated based upon a query parameter;
receiving a set of sentences from the initial set of search results;
generating a set of parse trees for each sentence in the set of sentences, wherein a parse tree comprising a plurality of terms;
generating one or more dependency graphs for one or more parse trees from the set of parse trees, wherein a dependency graphs comprises:
the query parameter as a root node; and
a plurality of nodes associated with the plurality of terms from an associated parse tree;
determining, for the one or more dependency graphs, a plurality of scores, wherein a score from the plurality of scores is associated with a node from the plurality of nodes in the dependency graph, and wherein the score represents a relationship between a term associated with the node and the query parameter; and
generating, based upon the plurality of scores, insight data for the initial set of search results, wherein the insight data provides contextual information for the initial set of search results.

18. The computer storage medium of claim 17, wherein the plurality of nodes comprise terms that are either nouns or adjectives.

19. The computer storage medium of claim 18, wherein the plurality of nodes further comprise terms that are connected to the query parameter in an associated parse tree.

20. The computer storage medium of claim 20, wherein determining a plurality of scores for the one or more dependency graphs comprises executing a PageRank algorithm on the one or more dependency graphs.
